(19) United States
(12) Patent Application Publication
(10) Pub. No.: US 2007/0121817 A1
(43) Pub. Date: May 31, 2007

(54) Confirmation on interactive voice response messages

(76) Inventors: Yigang Cai, Naperville, IL (US); Xiang Yang Li, Beijing (CN)

Correspondence Address: Werner Ulrich, 434 Maple Street, Glen Ellyn, IL, 60137-3826, US

(21) Appl. No.: 11/291,012

(22) Filed: Nov. 30, 2005

(51) Int. Cl. H04M 11/00

(52) U.S. Cl. 379/88.13

(57) ABSTRACT

This invention relates to a method and apparatus for providing a telecommunications customer with a data message as well as a voice message for confirming a transaction. An interactive voice response system provides the voice message, and also triggers the transmission of an e-mail, short message service or instant message service message to the customer whose requested transaction is being confirmed. Advantageously, the customer receives both oral notification and a record of the transaction.

### TECHNICAL FIELD

Apparatus and a method for automatically providing confirmation of the subject matter of automatically generated voice announcements.

### BACKGROUND OF THE INVENTION

Automatically generated voice announcements have been increasingly used to inform customers of an action taken by a supplier, vendor, or provider of service. For example, many clinics automatically generate an announcement to remind their customers that they have an appointment to see a particular doctor at a particular time on a particular day. More complex announcements are also available, such as announcements by a pharmaceutical supply house that a particular prescription has been filled and will be mailed on such and such a date.

A problem with such systems is that the reliability of the customer's actually receiving the desired message is less than 100%. Further, if the message contains specific numeric information, such as a prescription number, the customer may not be able to record that number at the time the message is received and the ability to have the message repeated may cause problems for that customer. Accordingly, a problem of the prior art is that the arrangements for transmitting automatically generated voice announcements and for ensuring that these announcements are properly received are far from perfect.

### SUMMARY OF THE INVENTION

Applicants have carefully studied this problem and have inventively recognized that it would be desirable to automatically supplement the voice message with some form of record such as an e-mail message, a short message service message, multimedia message service message or an instant message. In accordance with Applicants' invention, the interactive voice response system which generates a voice message for transmission to a customer also generates a corresponding data message for transmission to a system such as an e-mail server, a short message service center, or an instant message service center for transmission to a terminal accessed by the destination customer of the voice message. Advantageously, this arrangement ensures that a customer not only receives a voice message, but some form of message record.

In accordance with one preferred embodiment of Applicants' invention, an interactive voice response system is enhanced to generate a data message, corresponding to the voice message, for transmission to a data terminal of the customer. The enhanced interactive voice response system contains templates for generating not only voice announcements based on data received from a confirmation system, but also contains templates for generating e-mail messages, short messages, or instant messages. The addresses of the devices for receiving the data messages are translated from the telephone number of the voice terminal received by the interactive voice response system in a table that can be stored either in the interactive voice response system or in a home subscriber server accessed by the interactive voice response system. The advantage of using the home subscriber server data tables is that these data tables are already part of an infrastructure of a telecommunications system and are centralized provisioned in the network and automatically updated within that infrastructure.

### BRIEF DESCRIPTION OF THE DRAWING(S)

FIG. 1 is a block diagram of the system of the prior art for providing interactive voice response unit generated messages to a customer;

FIG. 2 is a block diagram of an enhanced system in accordance with Applicants' invention for providing both voice and data to a customer; and

FIG. 3 is a flow diagram illustrating the operation of Applicants' invention.

### DETAILED DESCRIPTION

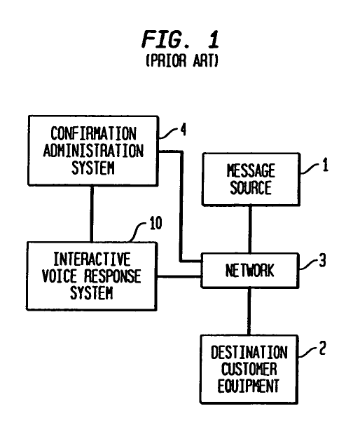

FIG. 1 is a block diagram of a prior art system. A message source 1, such as a pharmaceutical supply business, sends a message describing a transaction via a telecommunications network 3 to a confirmation administration system 4. The message received by the confirmation administration system includes the telephone number of the destination customer to whom the confirmation message should be announced. The confirmation administration system sends a data message to the interactive voice response system 10 providing the destination customer telephone number and the data of the transaction (for example, the prescription number, date at which the prescription will be mailed to the customer, identity of the prescribing physician, etc.) The interactive voice response system uses this data in conjunction with a template stored for the particular message source to generate a voice message for delivery via network 3 to the destination customer 2.

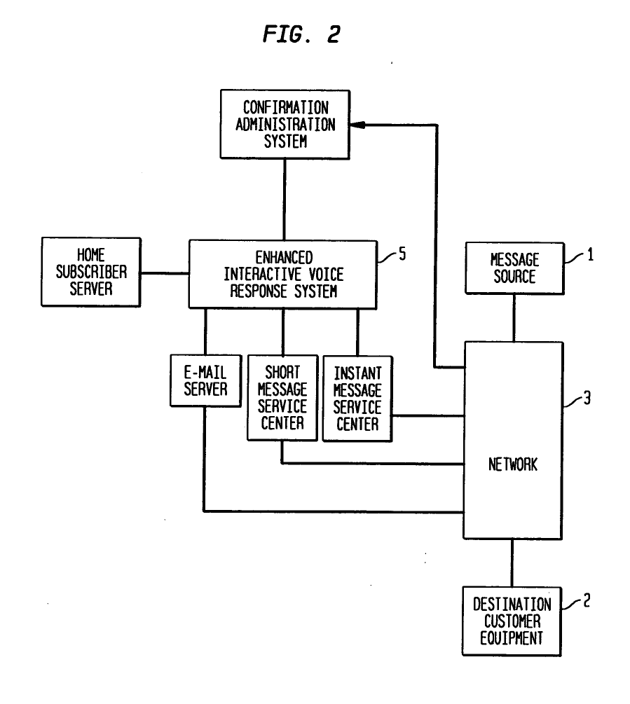

FIG. 2 is a block diagram illustrating the operation of Applicants' invention. The message source 1 sends a message via network 3 to the confirmation system 4 as in the prior art. The confirmation system sends a message to an enhanced interactive voice response system 5 containing the data of the message which is to be sent to the customer. The same voice message as in the prior art is sent via network 3 to destination customer 2. In addition, the enhanced interactive voice response system has templates for the messages of the source for generating e-mail, short messages/multimedia messages, or instant messages. The enhanced interactive voice response system contains tables to translate between destination customer telephone numbers and the identity of data terminal[s] also serving that customer. The enhanced interactive voice response system can verify with the home subscriber server (HSS) 9 whether the destination user is provisioned with SMS/MMS/Email services and addresses. The addresses are provisioned by the telecommunications carrier. The HSS database is managed by the carrier operator. The database can be shared with other applications in the network. Based on data provided by the HSS, the enhanced interactive voice response system can determine whether it should send and SMS/MMS/Email confirmation message when providing a voice announcement. The home subscriber server also can provide the selection of whether the enhanced interactive voice response system should send voice notification only, or voice notification plus any specified combination of short message service (SMS), multimedia message service (MMS) or E-mail notification. The end user or service provider can provision the data of the home subscriber server database. The end user may need to subscribe to a service to enable SMS/MMS/Email confirmation service.

The enhanced interactive voice response system generates data messages for transmission to an e-mail server 6, a short message service center 7, or an instant message service center 8 all of which are connected to the network 3. The network then sends these messages to the appropriate data terminals owned by the destination customer 2. The enhanced interactive voice response system can be configured to send a data confirmation message during or after the interactive voice response session.

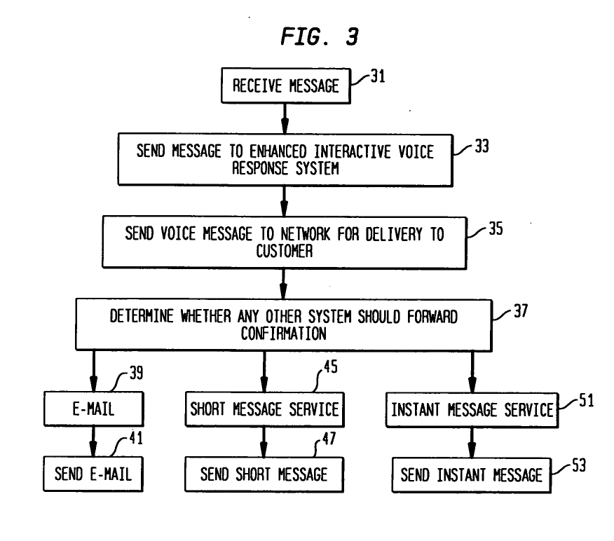

FIG. 3 is a flow diagram illustrating the operation of Applicants' invention. A message is received from a message source in a system such as confirmation system 4 (action block 31). The message is sent to the enhanced interactive voice response system (action block 33). This system generates a voice message and sends that voice message to a telecommunications network 3 for transmission to the customer (action block 35). The enhanced interactive voice response system, based on the telephone number received from the confirmation administration system, determines the identity and type of the data terminal[s] of the destination customer (test 37). If one of the data terminals is a terminal for receiving e-mail (action block 39) then e-mail is sent to that terminal via the network 3 (action block 41). If test 37 determines that a short message service device is to receive the confirmation (action block 45) then a short message is sent over the network to the appropriate short message service terminal (action block 47).

If test 37 determines that an instant message service terminal should receive the confirmation (action block 51) then an instant confirmatory message is sent to the instant message service terminal of the receiving customer (action block 53).

The above description is of one preferred embodiment of Applicants' invention Other embodiments will be apparent to those of ordinary skill in the art. The invention is limited only by the attached claims.

We claim:

1. In a telecommunications system, means for providing confirmation of a transaction to a destination customer comprising:
a confirmation system process for receiving messages from a message source describing a transaction to be confirmed;
an enhanced interactive voice response system responsive to a message from said confirmation system for generating a voice message describing the confirmation, said voice message for transmission to said destination customer;
said interactive voice response system for further controlling the sending of a data message comprising confirmation information for said transaction to a data terminal of said destination customer.

2. The apparatus of claim 1 wherein said data terminal is a terminal for receiving e-mail and said enhanced interactive voice response system transmits a confirmation message to an e-mail server for transmission to said e-mail terminal of said destination customer.

3. The apparatus of claim 1 wherein said data terminal of said destination customer is a short message service terminal and wherein said enhanced interactive voice response system transmits a message to a short message service center for transmission to said short message service terminal of said destination customer.

4. The apparatus of claim 1 wherein said destination customer terminal is an instant message terminal and wherein said enhanced interactive voice response system transmits a message to an instant message service center for transmission to said instant message service terminal of said destination customer.

5. The apparatus of claim 1 wherein said enhanced interactive voice response system comprises a data table for translating between said telephone number of said destination customer and an identity of said data terminal of said destination customer.

6. The apparatus of claim 1 wherein a home subscriber server comprises translation tables for translating between a telephone number of said destination customer and an identity of said data terminal of said destination customer.

7. The apparatus of claim 1 wherein said data message is sent after said enhanced interactive voice response system has provided said message to said destination customer.

8. The apparatus of claim 1 wherein said data message is sent before said enhanced interactive voice response system has provided said message to said destination customer.

9. In a telecommunications system, a method of providing confirmation of a transaction to a destination customer comprising the steps of:
receiving a message from a message source describing a transaction to be confirmed;
an enhanced interactive voice response system responsive to receipt of said message, generating a voice message describing the confirmation for transmission to said destination customer;
further controlling the sending of a data message comprising confirmation information for said transaction to a data terminal of said destination customer.

10. The method of claim 9 wherein the step of controlling the sending of a data message comprises the step of controlling the transmission of an e-mail message to said destination customer.

11. The method of claim 9 wherein the step of controlling the sending of a data message comprises the step of controlling transmission of a short message service (SMS) message to a short message service center for transmission to said destination customer.

12. The method of claim 9 wherein the step of controlling the sending of a data message comprises the step of controlling transmission of an instant message to said destination customer.

13. The method of claim 9 wherein the step of controlling the sending of a data message comprises the step of accessing a data table for translating between a telephone number of said destination customer and an identity of said data terminal of said destination customer.

14. The method of claim 9 wherein the step of controlling the sending of a data message comprises the step of accessing a home subscriber system comprising translation tables for translating between a telephone number of said destination customer and an identity of said data terminal of said destination customer.

15. The method of claim 9 wherein the step of controlling the sending of a data message comprises the step of sending said data message after said enhanced interactive voice response system has provided said message to said destination customer.

16. The apparatus of claim 9 wherein the step of controlling the sending of a data message comprises the step of sending said data message before said enhanced interactive voice response system has provided said message to said destination customer.
